(19) United States
(12) Patent Application Publication
(10) Pub. No.: US 2019/0303266 A1
(43) Pub. Date: Oct. 3, 2019

(54) STRING TRANSFORMATION BASED TRACE CLASSIFICATION AND ANALYSIS

(71) Applicant: CA, Inc., New York, NY (US)

(72) Inventor: Christopher Phillip Bonnell, Longmont, CO (US)

(21) Appl. No.: 15/937,522

(22) Filed: Mar. 27, 2018

(51) Int. Cl. G06F 11/36; G06F 17/30; G06F 11/34; G06F 11/30

(52) U.S. Cl. CPC G06F 11/3608; G06F 17/30949; G06F 11/302; G06F 11/3466; G06F 17/30958

(57) ABSTRACT

Distributed application traces can be transformed into strings to facilitate analysis which would be at least difficult, if even possible, with the distributed application traces as directed acyclic graphs (“DAGs”). A trace class analyzer can generate a string representation of a DAG. The trace class analyzer constructs the string with tokens for each node in the trace. Eventually, the trace class analyzer will have generated trace strings that each identify a class of traces. Each trace string can be considered an identifier for a trace class. The trace class analyzer determines the edit distances among the trace strings. The edit distances correspond to behavioral variation across the trace classes. The trace class analyzer can then use the edit distances as the basis for generating a visualization of the behavior variation across trace classes for anomaly detection and root cause analysis.

### BACKGROUND

The disclosure generally relates to the field of data processing, and more particularly to artificial intelligence.

Generally, a distributed application is an application that includes software components throughout a distributed system in which the computers or machines may be physical machines or virtual machines. The distributed application presents a single interface to a client for requesting a transaction to be performed. Performing the transaction includes performing multiple operations or tasks, or “end-to-end” tasks of the transaction. Each of the distributed software components handles a different subset of those tasks. This application architecture allows for a more flexible and scalable application compared with a monolithic application.

With the rise of cloud computing and mobile devices, large-scale distributed systems with a variety of components, such as systems based on a microservices architecture or Service-Oriented Architecture (SOA), have become more common. Various distributed tracing tools have been developed to perform root cause analysis and monitoring of large-scale distributed systems. A distributed tracing tool traces the execution path of a transaction as it propagates across the software components of a distributed system. As the components are executed (e.g., remote procedure calls, remote invocation calls, application programming interface (API) function invocations, etc.), the component is identified and the sequence of calls/invocations are correlated to present the trace.

### BRIEF DESCRIPTION OF THE DRAWINGS

Embodiments of the disclosure may be better understood by referencing the accompanying drawings.

FIG. 1 is a conceptual diagram of a trace class analyzer analyzing behavior across trace classes of a distributed application.

FIG. 2 is a flowchart of example operations for generating a trace string from a distributed application trace and for updating a trace class repository.

FIG. 3 is a flowchart of example operations for constructing a trace string based on a trace action symbol map and trace string construction rules.

FIG. 4 is a flowchart of example operations for determining edit distances among trace strings.

FIG. 5 depicts an example computer system with a trace class analyzer.

### DESCRIPTION

The description that follows includes example systems, methods, techniques, and program flows of embodiments of the disclosure. However, it is understood that this disclosure may be practiced without these specific details. In other instances, well-known instruction instances, protocols, structures and techniques have not been shown in detail in order not to obfuscate the description.

Overview

Distributed application traces can be transformed into strings to facilitate analysis which would be at least difficult, if even possible, with the distributed application traces as trees or as directed acyclic graphs (“DAGs”). A trace class analyzer can generate a string representation of a DAG that indicates propagation or execution of a transaction through distributed application components (e.g., software and/or hardware components). This string representation summarizes the trace for trace classification. The trace class analyzer constructs the string with tokens for each node in the trace. Each token of the string will indicate at least two aspects of the node: 1) an action or event corresponding to the node, and 2) a number of dependencies (i.e., children) upon that action or event. Eventually, the trace class analyzer will have generated trace strings that each identify a class of traces. Each trace string can be considered an identifier for a trace class. The trace class analyzer determines the edit distances among the trace strings. The edit distances correspond to behavioral variation across the trace classes. The trace class analyzer can then use the edit distances as the basis for generating a visualization of the behavior variation across trace classes for anomaly detection and root cause analysis. In addition, summarization of traces with strings allows for statistical analysis of the trace classes.

Example Illustrations

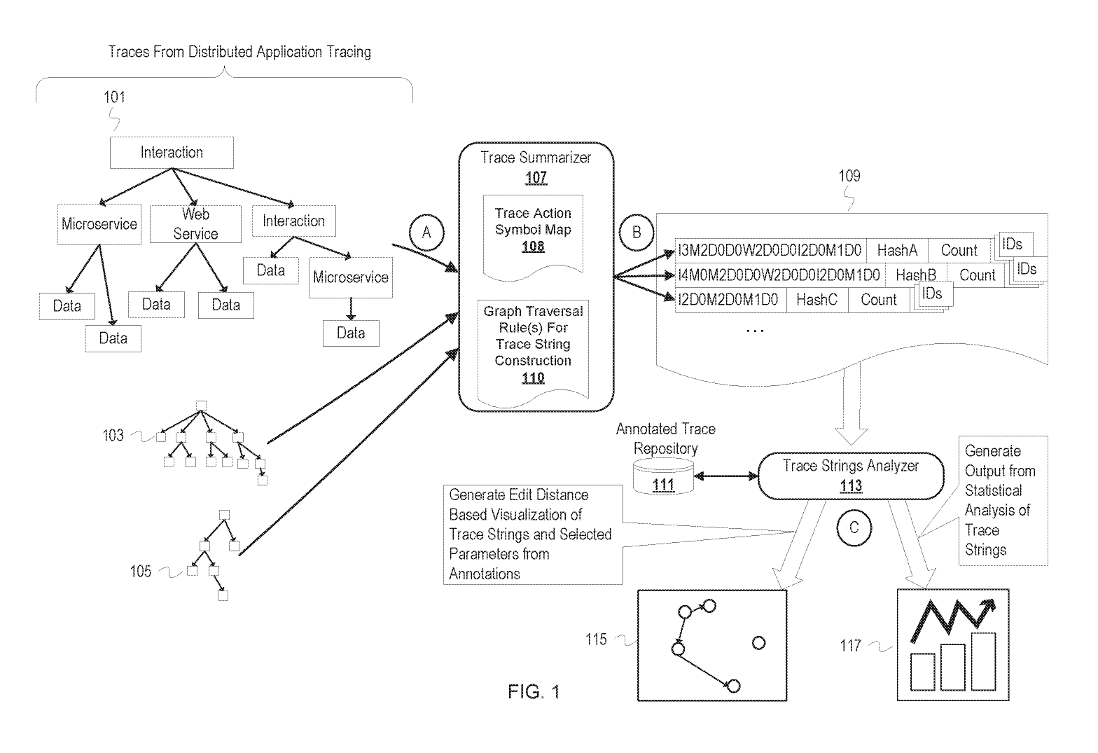

FIG. 1 is a conceptual diagram of a trace class analyzer analyzing behavior across trace classes of a distributed application. An example program that analyzes behavior across classes of distributed application traces (“trace class analyzer”) comprises a trace summarizer 107 and a trace strings analyzer 113. The trace class analyzer reads or receives traces of a distributed application (“distributed traces”) generated by a tracing tool or other application performance management tool/monitor. The trace class analyzer reads or receives each trace in a form of a DAG (i.e., a data structure(s) that corresponds to a DAG). The trace summarizer 107 summarizes each of these traces by transforming the trace into a string and then updating a trace class repository 109. The trace strings analyzer 113 performs analysis of the trace classes in the trace class repository 109.

FIG. 1 is annotated with a series of letters A-C. These letters represent stages of operations, each of which may be one or more operations. Although these stages are ordered for this example, the stages illustrate one example to aid in understanding this disclosure and should not be used to limit the claims. For instance, the stages can overlap. Subject matter falling within the scope of the claims can vary with respect to the order and some of the operations.

At stage A, the trace summarizer 107 summarizes traces 101, 103, 105. The trace summarizer 107 uses a trace action symbol map 108 and a graph traversal rule(s) 110 for trace string construction. The trace action symbol map 108 maps information in a node of a trace to a symbol. As an example, interaction type events map to the character “I” and calls to a microservice map to a character “M.” The elements and size of the trace action symbol map are determined according to a degree of coarseness desired for the trace class analysis. For instance, every action can map to a same character in which case a token could be a same symbol across all nodes in association with the count of children, or could just be the count of children of a node. As an example of a finer granularity of trace class analysis, a trace action symbol map can each action (e.g., each web service call, each microservice call, each database call, each page interaction, etc.) to a different symbol. The graph traversal rule(s) 110 specifies how the trace organization is reflected in the trace string. To illustrate, the graph traversal rule(s) 110 can specify that token insertion into the trace string being constructed prioritizes leftmost subtree and/or nodes with a greatest number of children. While graph traversal rules can specify that a trace string be constructed as the trace is organized, a less stringent correspondence can reduce the number of trace strings that are tracked and analyzed by disregarding nominal differences in ordering that do not impact application performance or have a low likelihood of impacting application performance.

For this illustration, example details are depicted for trace 101 but not the other traces 103, 105. The trace 101 includes a root span or root node labeled as “Interaction.” An interaction may be a page load, click event, input submission, etc. The Interaction node had 3 call dependences or children: a node labeled “Microservice,” a node labeled “Web Service,” and another node labeled “Interaction.” A node labeled Microservice corresponds to a call to a microservice and a node labeled Web Service corresponds to a call to a web service. The Microservice node that depends upon the root node has 2 children that are both labeled “Data.” A node labeled “Data” corresponds to a query of a database or data store. The Web Service node that depends upon the root node also has 2 children that are both labeled “Data.” The Interaction node that depends upon the root node has a child node labeled “Data” and a child node labeled “Microservice.” The Microservice node that depends upon the non-root Interaction node has a single child labeled “Data.”

At a stage B, the trace summarizer 107 updates the repository 109 based on the trace string constructions. For each trace string constructed, the trace summarizer 107 generates a trace class signature or hash value of the trace string. If the trace summarizer 107 finds a matching trace signature already in the repository 109, then the corresponding entry is updated. Updating of an entry in the trace class repository 109 includes updating a count of observed traces in the trace class corresponding to the hash value and inserting the trace identifier of the source trace into a listing of trace identifiers that have been observed for the trace class. For the trace 101, the trace summarizer 107 constructed a trace string “I3M2D0D0W2D0D0I2D0M1D0” and generated a hash value HashA. The trace string for the trace 101 is indicated in a first entry of the repository 109. The traces 103, 105 are respectively indicated in the second and third entries of the repository 109. For the trace 103, the second entry indicates a trace string “I4M0M2D0D0W2D0D0I2D0M1D0,” a hash value HashB, and a listing of trace identifiers observed for the trace class. For the trace 105, the second entry indicates a trace string “I2D0M2D0M1D0,” a hash value HashC, and a listing of trace identifiers observed for the trace class.

Based on an analysis trigger or criterion, the trace strings analyzer 113 can perform statistical analysis with the trace classes and can perform analysis based on edit distances among the trace strings as illustrated in stage C. Analysis can be automatically triggered based on a number of traces observed, based on a number of trace classes identified, based on a schedule, etc. Analysis based on the trace strings can also be explicitly triggered (e.g., input of a command). For the statistical analysis, the trace strings analyzer 113 can generate output from correlating the counts of each trace string to other statistical information based on the associated traces. For example, the trace strings analyzer 113 can compute the average latency and deviation within each trace class and present a visualization that correlates trace string frequency with the average latency and deviation per trace string. In addition, the trace strings analyzer 113 can compute edit distances among the trace strings and present a visualization of the trace classes as points separated based on edit distances. The proximity of the points representing trace classes can aid in root cause analysis, debug, and/or user experience evaluation. In addition, the trace strings analyzer 113 can modify the visualization and/or allow drilling into the points based on a parameter(s) selected from the trace annotations. After determining edit distances among the trace strings in the repository 109, the trace strings analyzer 113 can look up in an annotated trace repository 111 the annotations for each trace identified within each trace class identified by the trace strings. The trace strings analyzer 113 can present a visualization of the trace classes based on the edit distances as a distribution of points per trace class. The trace strings analyzer 113 can then modify the graphical rendering of each point based on a selected set of one or more parameters in the annotations. For example, the trace strings analyzer 113 can adjust the size of the point for trace class based on number of different users that initiated the transaction corresponding to the traces in the trace class and color code based on average transaction completion time.

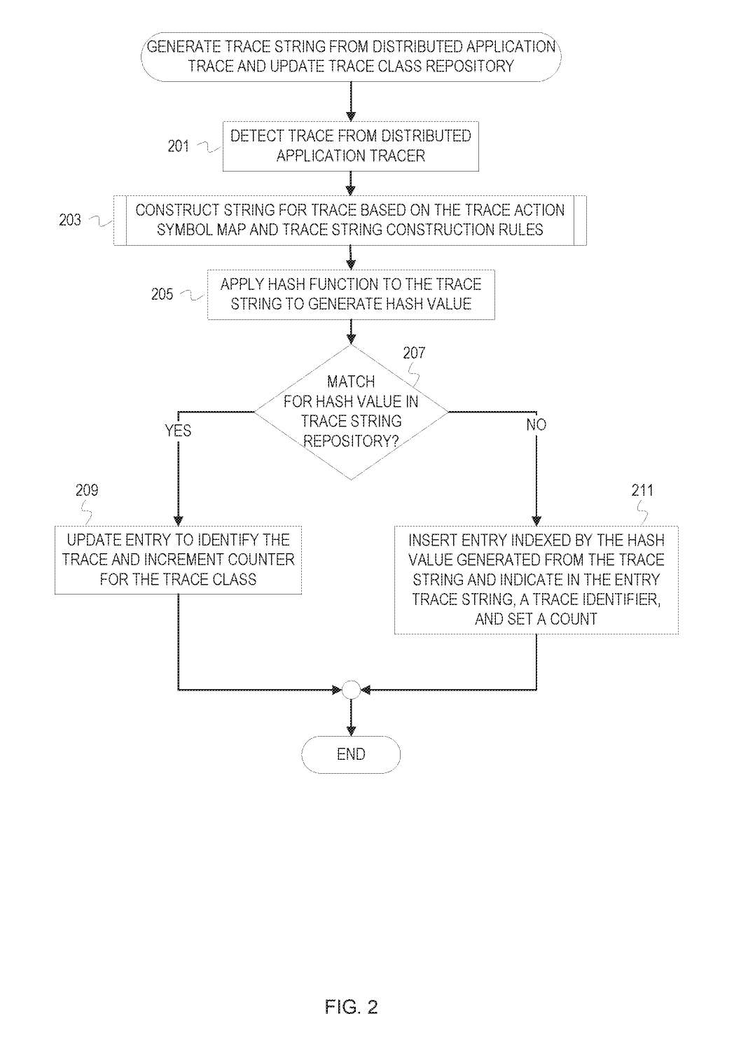

FIG. 2 is a flowchart of example operations for generating a trace string from a distributed application trace and for updating a trace class repository. For consistency with FIG. 1, the description of the example operations of the flowcharts will refer to a trace class analyzer as performing the operations.

A trace class analyzer can detect a trace from a distributed trace analyzer with various techniques (201). A tracer, which may be standalone or part of an application monitoring application/tool, can incrementally build traces describing the code path or execution path of a transaction for a distributed application. The trace class analyzer can periodically read one or more memory/store locations where these traces reside or register interest or subscribe to receive the traces. In some cases, a trace class analyzer may be integrated closely with the tracer and access a trace as it is being built. The trace class analyzer may determine that a trace is complete explicitly or inferentially. The tracer can set a flag or notify the trace class analyzer when a trace is complete. Or the trace class analyzer can infer that a trace is complete. For instance, the trace class analyzer can infer that a trace is complete after a defined amount of time, observation of a particular action (e.g., purchase confirmation), and/or after observation of a defined number of actions (e.g., a maximum possible number of actions for the distributed application or transaction type).

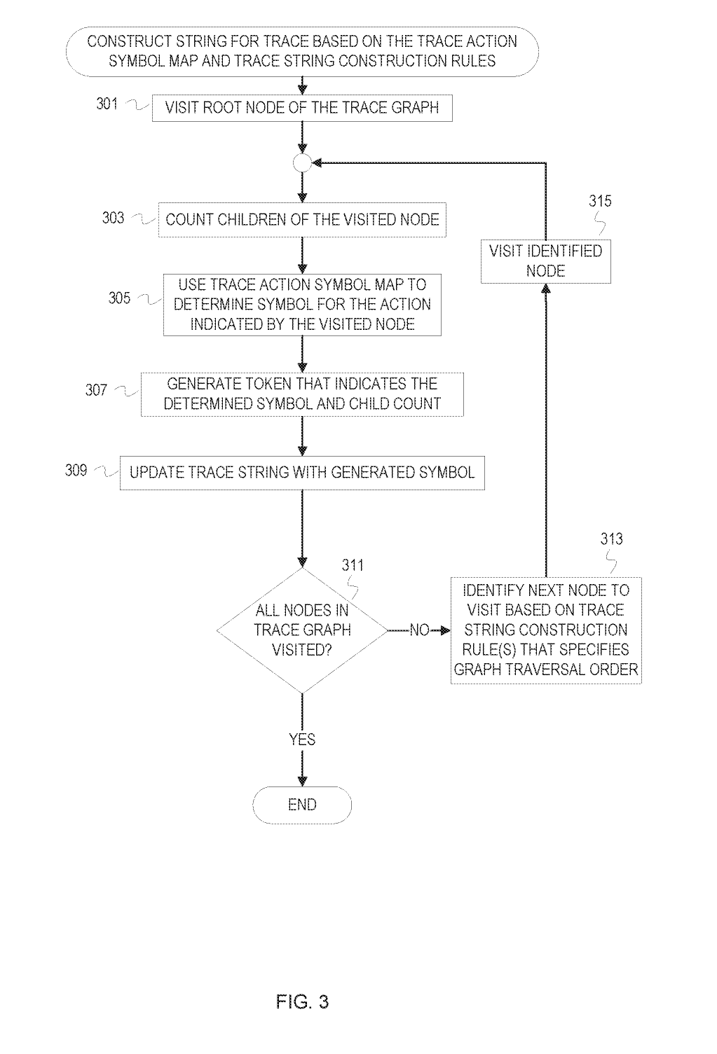

Based on detection of a trace, the trace class analyzer constructs a string for the trace using a trace action symbol map and a set of trace string construction rules (203). Example operations for trace string construction is provided with FIG. 3. The trace class analyzer accesses a trace action symbol map and searches the trace action symbol map for symbols defined for the actions indicated in the trace. The trace action symbol map can include an entry for each type of action of the distributed application or for each action of the distributed application. A trace action symbol map can be designed that specifies symbols for action types and a symbol(s) for a particular action(s) of interest. For instance, an inventory update or call to a specific database may be of more interest than other actions. In other words, a trace action symbol map can map symbols at varying scopes of trace elements. In addition to symbols for actions in a trace, the trace class analyzer indicates a count of children of each node. Thus, the trace class analyzer constructs a string of tokens, each token being constructed from a symbol and child node count. The trace class analyzer constructs the strings according to string construction rules that specify how to traverse the graph to consistently construct a trace string.

After constructing the trace string, the trace string analyzer applies a hash function to the trace string to generate a hash value (205). While the trace string can be used as a trace class identifier, the trace class analyzer uses the hash value as a compact trace class identifier that facilitates efficient search of the repository of trace strings. Embodiments can forgo generating and using the hash value to search the trace string repository, and rely on the trace string itself if the cost of the string compares is not a concern.

The trace class analyzer searches the trace string repository for the generated hash value (207) to determine whether the detected trace is within an already observed trace class or is a basis for a trace class not currently indicated in the trace string repository. If the generated hash value is found in the trace string repository, then the trace class analyzer updates the matching entry to identify the trace and increment a counter for the trace class (209). The trace class analyzer maintains a count for each trace class for statistical analysis of the trace classes. The trace class analyzer also maintains in association with the trace class entry an array or listing of identifiers of the detected traces within the matching trace class. As each trace is created by the tracer, it is assigned a trace identifier. The trace identifier can later be used to access the measurements and other monitoring data that were collected for that trace and stored as annotations on the trace. If the trace class analyzer does not find a match for the generated hash value, then the trace class analyzer updates the repository by inserting an entry for the newly detected trace class (211). The trace class analyzer can use the hash value as an index to the entry. In the entry, the trace class analyzer writes the trace string, an identifier of the detected trace, and sets a count for the trace class.

FIG. 3 is a flowchart of example operations for constructing a trace string based on a trace action symbol map and trace string construction rules. The trace action symbol map can be specific to the distributed application or designed for a type of distributed application (e.g., a trace action symbol map for e-commerce platforms). As in FIG. 2, the description refers to a trace class analyzer as performing the operations of FIG. 3.

The trace class analyzer traverses the trace, which is in the form of a tree or DAG, and determines at least an action represented by the node and number of children in order to construct a string that reflects the execution path. After detecting a trace, the trace class analyzer visits a root node of the detected trace (301). The trace class analyzer counts children of the visited node (303). The trace class analyzer can count the number of edges or references from the visited node. The trace class analyzer uses the trace action symbol map to determine a symbol for the action indicated by the visited node (305). The trace class analyzer may search the symbol map based on a name of the action indicated by the node, a different attribute of the node, or an additional attribute of the node. The symbol may be a character. For example, the trace class analyzer may search the trace action symbol map with the name of a function called and find a character that maps to an action type corresponding to the function call. With the count of children and the determined symbol, the trace class analyzer generates a token for the node (307). For instance, the trace class analyzer appends the child count to the determined symbol. The trace class analyzer then updates the trace string with the generated token (309). For the root node, the trace class analyzer inserts the generated token as the first token of an empty trace string. For subsequent tokens, the trace class analyzer can append each generated token.

The trace class analyzer then determines whether trace traversal has been completed or whether there are still nodes to visit in the trace (311). If all nodes in the trace have been visited, then the construction process ends. Otherwise, the trace class analyzer identifies a next node to visit based on the trace string construction rule(s) (313). The trace string construction rule may be based on a traversal algorithm, such as depth first search or breadth first search. The trace string construction rule may specify that nodes should be visited in order of greatest count of children to least, and that ties should be resolved based on left or right orientation within the trace and/or the symbols. Upon identifying the next node to visit, the trace class analyzer visits the next node (315) and processes the visited node to continue with string construction (303).

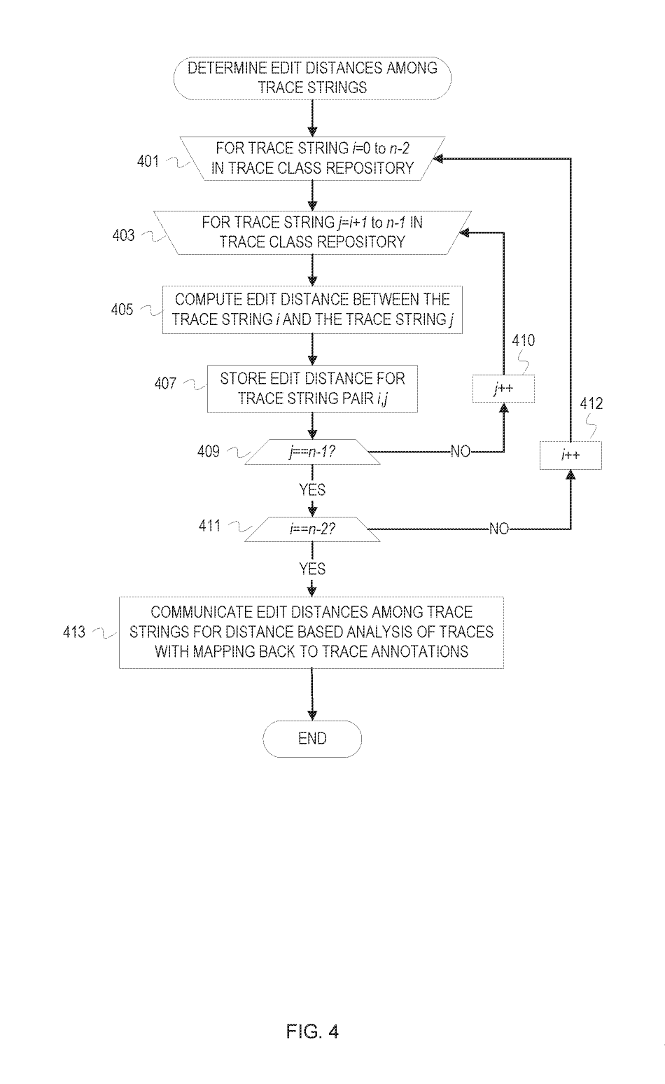

FIG. 4 is a flowchart of example operations for determining edit distances among trace strings. A trace class analysis criterion can be set that causes edit distances to be computed and used for analysis of trace classes. The criterion likely is satisfied after a sufficient number of traces have been detected and/or a sufficient number of trace classes have been encountered (e.g., at least a number of trace classes that is greater than 80% of the types of transaction offered by the distributed application). After edit distances are initially computed, the trace class analyzer can track added trace classes without edit distances and compute the edit distances for the newly detected trace classes at intervals.

A trace class analyzer begins iterating over pairs of trace strings to determine edit distances between the different pairings. Using i and j as iteration indices, the trace class analyzer determines edit distances between trace strings i and j. The trace class analyzer selects from a trace string repository a trace string i, which iterates from 0 to n−2 when there are n trace strings (401). The trace class analyzer then selects a trace string j, which iterates from i+1 to n−1 (403). The trace class analyzer then computes the edit distance between the trace string i and the trace string j (405). The trace class analyzer can compute the edit distance according an available edit distance algorithm (e.g., the Levenshtein distance algorithm or Wagner-Fischer algorithm). However, the trace class analyzer can use different bookkeeping for the distance units that corresponds to the variation across traces. As an example:
change in activity symbol of a token (e.g., A3→I3)=1 distance unit;
increasing a child count of a token and adding a token to the string=1 distance unit;
decreasing a child count of a token and removing a token from the string=1 distance unit.
   As another example, edit distances of an algorithm can be compressed by ranges. For instance, every 3 distance units output from applying a Levenshtein distance algorithm can be compressed into a single distance unit.

After computing the edit distance between the pair of selected trace strings, the trace class analyzer stores the edit distance as distance_{i,j} for the pair of trace strings (407) and proceeds with computing edit distances for the other pairings. In this example implementation, the trace class analyzer determines whether all trace strings from i+1 to n−1 have been paired with trace string i and edit distances computed and stored (409). If not, then j is incremented (410) and the next pairing with trace string i is made and edit distance computed. If so, then the trace class analyzer determines whether all trace strings from 0 to n−2 have been iterated over (411). If not, then i is incremented (412) and the next trace string i is selected. After edit distances have been computed for the different pairings of trace strings, the trace class analyzer communicates the computed edit distances for distance based analysis (413). The trace class analyzer can generate a visualization of the trace classes as points distributed across a space based on the edit distances of the trace strings. The points or other graphical depiction can be control objects that allow access to the various parameters in annotations of the underlying traces as aggregations (e.g., averages across traces within a trace class) or detailed listings (e.g., listing latencies of individual traces within a trace class).

Variations

The examples often refer to a “trace class analyzer.” The trace class analyzer, as well as the trace summarizer and trace strings analyzer, is a construct used to refer to implementation of functionality for transforming traces into trace strings and analyzing the trace strings. This construct is utilized since numerous implementations are possible due to different platforms, different programming languages, changing best programming practices, programmer preferences, etc. The term is used to efficiently explain content of the disclosure.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 303 and 305 can be performed in parallel or concurrently. In addition, the manner of iterating and pairing can vary from that depicted in FIG. 4. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

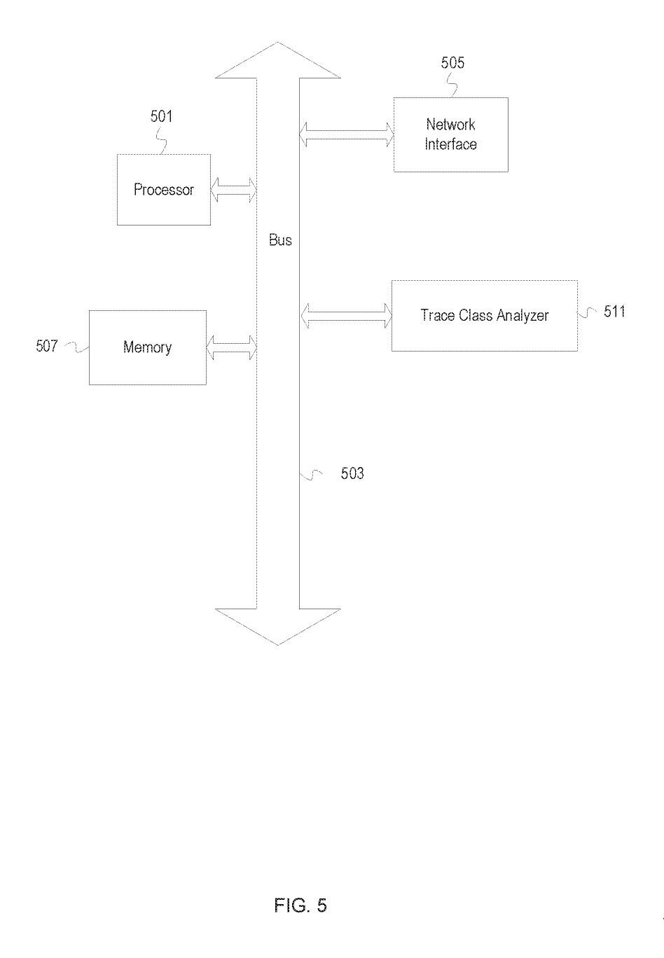

FIG. 5 depicts an example computer system with a trace class analyzer. The computer system includes a processor 501 (possibly including multiple processors, multiple cores, multiple nodes, and/or implementing multi-threading, etc.). The computer system includes memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 503 (e.g., PCI, ISA, PCI-Express, HyperTransport® bus, InfiniBand® bus, NuBus, etc.) and a network interface 505 (e.g., a Fiber Channel interface, an Ethernet interface, an internet small computer system interface, SONET interface, wireless interface, etc.). The system also includes a trace class analyzer 511. The trace class analyzer 511 generates strings from traces classifies the traces into the trace classes. The trace class analyzer 511 can then compute edit distances among the trace strings to aid in analysis of the traces. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

While the aspects of the disclosure are described with reference to various implementations and exploitations, it will be understood that these aspects are illustrative and that the scope of the claims is not limited to them. In general, techniques for summarizing traces into trace strings and analyzing the strings as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
constructing a first string from a first trace of a transaction through a distributed application;
determining whether a repository of strings constructed from traces through the distributed application includes the first string;
based on a determination that the repository includes a first entry with the first string, associating a first trace identifier that identifies the first trace with the first entry;
based on a determination that the repository does not include the first string, updating the repository with a first entry comprising the first string and associating a first trace identifier that identifies the first trace with the first entry; and
determining a first plurality of edit distances between the first string and a plurality of strings in the repository.

2. The method of claim 1, wherein constructing the first string from the first trace comprises constructing the first string with a token for each node of the first trace, wherein each token indicates an action of a corresponding node and a count of child nodes depending upon the corresponding node.

3. The method of claim 2, wherein constructing the first string with a token for each node comprises ordering the tokens according to traversal of the first trace.

4. The method of claim 3, wherein order of traversal of the first trace is based, at least in part, on count of child nodes.

5. The method of claim 2, wherein constructing the first string with a token for each node of the first trace comprises using a symbol map to determine, for each node in the first trace, a symbol that maps to the action indicated in the node.

6. The method of claim 5, wherein the symbol map comprises mappings of action types to symbols.

7. The method of claim 1 further comprising updating a count of traces in the first entry, wherein the count of traces is a count of traces from which the first string has been constructed.

8. The method of claim 1, wherein associating the first trace identifier with the first entry comprises inserting the first trace identifier into an array associated with the first entry.

9. The method of claim 1 further comprising generating a first hash value from the first string, wherein the first entry is indexed by the first hash value.

10. The method of claim 1 further comprising communicating for generation of a graphical depiction the first plurality of edit distances and a second plurality of edit distances and identifiers of the first string and the plurality of strings, wherein the second plurality of edit distances comprise edit distances among the plurality of strings.

11. One or more non-transitory machine-readable media comprising program code for trace classification by string transformation, the program code comprising instructions to:
based on detection of a trace through a distributed application, construct from the trace a string that identifies a trace class;
determine whether a repository of strings constructed from other traces through the distributed application indicates the trace class;
based on a determination that the repository indicates the trace class in an entry of the repository, associate a trace identifier that identifies the trace with the entry;
based on a determination that the repository does not indicate the trace class, update the repository with an entry comprising the string and associate a trace identifier that identifies the trace with the entry; and
determine edit distances between the string identifying the trace class and other strings identifying other trace classes in the repository.

12. The non-transitory machine-readable media of claim 11, wherein the instructions to construct the string comprise instructions to construct the string with a token for each node of the trace, wherein each token indicates an action of a corresponding node and a count of child nodes depending upon the corresponding node.

13. The non-transitory machine-readable media of claim 12, wherein the instructions to construct the string with a token for each node comprise instructions to order the tokens according to traversal of the trace.

14. The non-transitory machine-readable media of claim 13, wherein order of traversal of the trace is based, at least in part, on count of child nodes.

15. The non-transitory machine-readable media of claim 12, wherein the instructions to construct the string with a token for each node of the trace comprise instructions to use a symbol map to determine, for each node in the trace, a symbol that maps to the action indicated in the node.

16. The non-transitory machine-readable media of claim 11, wherein the program code further comprises instructions to update a count of traces in the entry, wherein the count of traces is a count of traces that belong to the trace class.

17. An apparatus comprising:
a processor; and
a machine-readable medium having instructions executable by the processor to cause the apparatus to,
based on detection of a trace through a distributed application, construct from the trace a string that identifies a trace class;
determine whether a repository of strings constructed from other traces through the distributed application indicates the trace class;
based on a determination that the repository indicates the trace class in an entry of the repository, associate a trace identifier that identifies the trace with the entry;
based on a determination that the repository does not indicate the trace class, update the repository with an entry comprising the string and associate a trace identifier that identifies the trace with the entry; and
determine edit distances between the string identifying the trace class and other strings identifying other trace classes in the repository.

18. The apparatus of claim 17, wherein the instructions to construct the string comprise instructions executable by the processor to cause the apparatus to construct the string with a token for each node of the trace, wherein each token indicates an action of a corresponding node and a count of child nodes depending upon the corresponding node.

19. The apparatus of claim 18, wherein the instructions to construct the string with a token for each node comprise instructions executable by the processor to cause the apparatus to order the tokens according to traversal of the trace.

20. The apparatus of claim 17, wherein the machine-readable medium further comprises instructions executable by the processor to cause the apparatus to update a count of traces in the entry, wherein the count of traces is a count of traces that belong to the trace class.
